(19) United States
(12) Patent Application Publication
(10) Pub. No.: US 2026/0249354 A1
(43) Pub. Date: Aug. 27, 2026

(54) IRON-BASED POWDER FOR OXYGEN REACTANT, AND OXYGEN REACTANT USING SAME

(71) Applicant: JFE STEEL CORPORATION, Chiyoda-ku, Tokyo (JP)

(72) Inventors: Naoki YAMAMOTO, Chiyoda-ku, Tokyo (JP); Kohsuke ASHIZUKA, Chiyoda-ku, Tokyo (JP); Shigeru UNAMI, Chiyoda-ku, Tokyo (JP)

(73) Assignee: JFE STEEL CORPORATION, Chiyoda-ku, Tokyo (JP)

(21) Appl. No.: 19/145,030

(22) PCT Filed: Sep. 27, 2023
(86) PCT No.: PCT/JP2023/035283

§ 371 Date: Jul. 1, 2025

(30) Foreign Application Priority Data
Feb. 14, 2023 (JP) 2023-021168

(51) Int. Cl. B22F 9/08

(52) U.S. Cl. CPC B22F 9/082; B22F 2009/0828; B22F 2301/35

(57) ABSTRACT

Provided is an iron-based powder for an oxygen reactant that has a low production cost and appropriately controlled reactivity with oxygen. The iron-based powder has a lattice interplanar spacing of 2.000 angstrom or more and 2.100 angstrom or less, as determined from a diffraction intensity curve corresponding to the (110) diffraction plane of α-Fe crystal among the diffraction peaks of X-ray diffraction.

### TECHNICAL FIELD

The present disclosure relates to an iron-based powder for an oxygen reactant and an oxygen reactant using the iron-based powder.

### BACKGROUND

Oxygen reactants that utilize the reaction between iron-based powder and oxygen are known to have applications as deoxidizing agents or heating agents. For example, as a deoxidizing agent, an oxygen reactant can be sealed inside a container along with food, pharmaceuticals, and the like to create a low-oxygen condition inside the container. Therefore, oxygen reactants are used to inhibit quality deterioration of preserved products due to oxidation, growth of mold, and the like. Further, oxygen reactants can be used as heating agents and are widely used as disposable body warmers to warm the human body and the like. Typically, in such oxygen reactants, activated carbon, sodium chloride, silica powder, wood powder, water, sulfur powder, and the like are added to iron-based powder to further promote the reaction between the iron-based powder and oxygen.

Further, in any application where the reaction rate between iron and oxygen is important, various methods have conventionally been considered as a means to control the reaction rate.

For example, in Patent Literature (PTL) 1, an iron powder is described for which the focus is on pore size distribution, specific surface area, particle size, metallic iron content, and the like, and these values are set within defined ranges in order to obtain good exothermic properties.

Further, in PTL 2, an activated iron powder is described in which the iron powder is partially covered with a carbonaceous substance.

Further, in PTL 3, an oxygen absorber is described in which an iron powder and other substance are mixed to form a mixed powder, and the full width at half maximum diffraction peak, specific surface area, average particle size, and the like are further controlled in order to obtain excellent oxygen absorption performance.

### CITATION LIST

### Patent Literature

PTL 1: WO 2017/082183 A1

PTL 2: JP 2003-117385 A

PTL 3: JP 2007-284632 A

### SUMMARY

### Technical Problem

However, the technology described in PTL 1 focuses on particle shape, such as pore size. Therefore, iron powder that does not meet the defined requirements for pore size is not used, leading to increased production costs.

Further, the technology described in PTL 2 not only requires a separate carbonaceous substance, but also requires partial coverage of the iron powder surface with the carbonaceous substance to a specified percentage. Further, when a coating property of the carbonaceous substance is poor, carbonaceous substance-derived dust is observed. Further, when the coating property of the carbonaceous substance is poor, target properties cannot be obtained.

Further, the technology described in PTL 3 requires mixing iron powder with halogenated metal and an alkaline substance, which results in high production costs.

In view of the problem described above, it would be helpful to provide an iron-based powder for an oxygen reactant that has a low production cost and appropriately controlled reactivity with oxygen, together with an oxygen reactant using the iron-based powder.

### Solution to Problem

It is known in the field of mechanochemistry that substances in a solid state change crystalline properties when subjected to stresses such as grinding, impact, and friction. And when the crystal structure of a solid is under strain, the substance in question becomes chemically active and more prone to chemical reactions.

To solve the problem described above, the inventors focused on the lattice interplanar spacing calculated from an X-ray diffraction intensity curve corresponding to the (110) plane of α-Fe crystal, which indicates the degree of strain of the crystal structure of iron-based powder particles, in order to promote the reaction between the iron-based powder and oxygen, and conducted extensive studies.

As a result, the inventors discovered that by setting the lattice interplanar spacing within a certain range, it is possible to produce an iron-based powder that has an appropriately controlled reactivity with oxygen.

The present disclosure is based on the discoveries described above, and primary features are as follows.
1. An iron-based powder for an oxygen reactant, the iron-based powder having a lattice interplanar spacing of 2.000 angstrom or more and 2.100 angstrom or less, as determined from a diffraction intensity curve corresponding to the (110) diffraction plane of α-Fe crystal among the diffraction peaks of X-ray diffraction.
2. An oxygen reactant using the iron-based powder for an oxygen reactant according to 1, above.

### Advantageous Effect

According to the present disclosure, by appropriately setting a range of lattice interplanar spacing of an X-ray diffraction intensity curve corresponding to the (110) plane of α-Fe crystal, which indicates the degree of strain of the crystal structure of iron-based powder particles, it is possible to produce iron-based powder that has appropriately controlled reactivity with oxygen at a low cost. Further, an oxygen reactant using the iron-based powder may be produced.

### DETAILED DESCRIPTION

Hereinafter, “iron-based powder” refers to a metal powder containing 50 mass % or more Fe.

Reasons why the iron-based powder for an oxygen reactant according to the present disclosure has excellent oxygen reactivity are presumed to be as follows.

As mentioned above, it is known that crystalline properties of substances in a solid state change when subjected to stresses such as grinding, impact, and friction, and in particular, lattice defects in the crystal structure increase. Such lattice defects cause mechanochemical effects and cause a substance to become chemically active.

In the case of iron-based powder, when mechanical energy is applied to the iron-based powder by grinding with a mill or mixing with a mixer, strain is applied to the crystal structure of the iron-based powder particles and reactivity with oxygen is increased. The strain of the crystal structure that occurs in the iron-based powder particles can be evaluated from the value of the lattice interplanar spacing obtained from the diffraction intensity curve corresponding to the (110) diffraction plane of α-Fe crystal among the diffraction peaks of X-ray diffraction.

When compressive stress due to mechanical energy is applied to the crystal lattice, in which the atoms composing α-Fe crystal are arranged three-dimensionally, the lattice interplanar spacing increases due to uniform strain. The effect of increased reactivity with oxygen increases with such an increase in strain. Therefore, the iron-based powder has a lattice interplanar spacing of 2.000 angstrom or more. The lattice interplanar spacing is preferably 2.010 angstrom or more. The lattice interplanar spacing is more preferably 2.020 angstrom or more. On the other hand, when the strain is excessive, the effect of improving reactivity with oxygen becomes significantly greater, making use as an oxygen reactant difficult. For example, when used as a deoxidizing agent, excessive heat generation causes food and pharmaceutical products to deteriorate due to heating. Further, there is a risk of burns due to excessive heat generation when used as a heating agent. Therefore, the iron-based powder has a lattice interplanar spacing of 2.100 angstrom or less.

According to the present disclosure, by making the iron-based powder for an oxygen reactant satisfy the above requirements, appropriately controlled reactivity may be achieved.

The iron-based powder may be used regardless of particle shape, and therefore specific surface area and average pore size of the iron-based powder are not particularly limited. However, the smaller the specific surface area, the less likely to react with oxygen and moisture in air, and the particle surface of the iron-based powder immediately after production is less likely to rust. Iron-based powder with little rust has a higher concentration of metallic iron, which further improves reactivity when used as an oxygen reactant. The specific surface area is therefore preferably 0.4 m²/g or less, for example. A lower limit of the specific surface area is not particularly limited and may be 0 m²/g or more. For the same reason as for specific surface area, an average pore size is preferably 5 μm or larger, for example.

Any iron-based powder may be used as the iron-based powder, without any particular limitation. Examples of the iron-based powder include iron powder and iron-based alloy powder. Hereinafter, “iron-based alloy powder” refers to alloy powder containing 50 mass % or more Fe. Further, “iron powder” refers to powder consisting of Fe and inevitable impurity, and is typically referred to as “pure iron powder” in the technical field. When the iron-based powder is an iron-based alloy powder, the iron-based alloy powder may further contain any element such as C, S, O, N, Si, Mn, P, S, Cr, Cu, or the like, in addition to Fe. When the iron-based powder is an iron powder, the iron powder may further contain any element such as C, S, O, N, Si, Mn, P, S, Cr, Cu, or the like as inevitable impurity.

The iron-based powder may be produced by water atomization, gas atomization, grinding, and oxide reduction methods, as described below.

The particle size of the iron-based powder is not particularly limited as long as no handling issues are caused. The median size D₅₀ is preferably 1 mm or less. The median size D₅₀ is more preferably 400 μm or less. The median size D₅₀ is more preferably 200 μm or less. On the other hand, a lower limit of the median size D₅₀ is not limited. However, the larger the particle size, the easier the iron-based powder is to handle. For example, when producing a deoxidizing agent product, iron powder is filled by free-fall from a thin tube into a packaging container. Excessively fine iron-based powder particle size results in powder clogging in the tube and scattering of the powder during filling. By increasing the particle size, the problems described above can be avoided. From this perspective, the median size D₅₀ is preferably 5 μm or more. The median size D₅₀ is more preferably 50 μm or more.

The median size (median particle size calculated from volume-based particle size distribution) D₅₀ of the iron-based powder is measured using a laser diffraction and scattering method. The specific measurement method is as follows.

The iron-based powder to be measured is put into a solvent (for example, ethanol), dispersed by ultrasonic oscillation for 30 s or longer, and the particle size is measured by a laser diffraction and scattering method using a laser diffraction particle size distribution analyzer. That is, volume-based particle size distribution of the iron-based powder particles is measured.

Cumulative particle size distribution is calculated from the particle size distribution obtained, and the particle size of the particle corresponding to 50% of the total volume of all particles is used as the median D₅₀ as a representative value of the particle size of the iron-based powder.

### [Method of Measuring Lattice Interplanar Spacing of α-Fe Crystal]

The method of measuring the lattice interplanar spacing of α-Fe crystal according to the present disclosure is as follows.

X-ray diffraction measurement is carried out on the target powder to obtain a diffraction intensity curve corresponding to the (110) diffraction plane of α-Fe. The lattice interplanar spacing can be calculated from a diffraction angle in the diffraction intensity curve and a wavelength of characteristic X-rays using Bragg's law indicated in Expression (1) below.

Specifically, the iron-based powder to be measured is scanned using Cu-Kα characteristic X-rays (wavelength: 1.54178 angstrom) at a scanning speed of 4°/min and a measurement angle range of 35° to 55°. The diffraction intensity curve corresponding to the (110) diffraction plane of α-Fe crystal in the iron-based powder is obtained. The lattice interplanar spacing is calculated from the diffraction angle and wavelength of characteristic X-rays.

$$2 d \cdot sin θ = n \cdot λ \qquad ( 1 )$$

d: lattice interplanar spacing (angstrom)
θ: diffraction angle (°)
n: natural number
λ: X-ray wavelength (angstrom)

### [Production of Iron-Based Powder]

Next, the method of producing the iron-based powder according to the present disclosure is described. The iron-based powder according to the present disclosure may be produced by any method. For example, the iron-based powder may be produced by further processing the iron-based powder by atomization, oxide reduction, or grinding methods to increase the α-Fe crystal strain. Here, the atomization method is a method to obtain metal powder by spraying molten metal with water or gas to form a spray that cools and solidifies. As the atomization method, either a water atomizing method or gas atomization may be used. An oxide reduction method, for example, reduces iron oxide (mill scale) or iron ore powder generated from steel sheet surfaces during hot rolling of steel material. In the grinding method, metal powder is obtained by grinding metal pieces. Further, the prepared powder may be classified and selected or mixed. The classification and selection and the mixing may be carried out by any method.

Next, the iron-based powder obtained by the method described above has almost no α-Fe crystal strain, and therefore processing the iron-based powder to increase the α-Fe crystal strain in the iron-based powder is required. The processing is preferably mechanical energy processing using a mixer or a grinder. The mixer is not particularly limited, and a V-shaped mixer, a double cone mixer, a conical blender, an agitation granulator, or the like may be suitably used. Further, the grinding is not particularly limited, and a ball mill, a vibration mill, a roller mill, a jet mill, a hammer mill, a disk mill, or the like may be suitably used.

Mixing conditions or grinding conditions in the case of using the mixer or the grinder as described above may be those of a conventional method, except that the strain of α-Fe crystal is adjusted to the range described above. For example, the lattice interplanar spacing of α-Fe crystal may be controlled by adjusting mixing time or grinding time.

Further, to improve reactivity with oxygen, when applying mechanical energy using the mixer or grinder, carbon powder such as activated carbon, coke powder, or the like may be added, and metal powder such as Cu, Ni, Mo, or the like may be added.

### [Oxygen Reactant]

According to an embodiment of the present disclosure, an oxygen reactant can be produced using the iron-based powder for an oxygen reactant described above. In other words, the oxygen reactant according to an embodiment of the present disclosure is an oxygen reactant using the iron-based powder for an oxygen reactant. The iron-based powder for an oxygen reactant according to the present disclosure has excellent reactivity with oxygen and is therefore suitable for use in the oxygen reactant. Accordingly, the oxygen reactant has the same effects as the iron-based powder for an oxygen reactant.

The components of the oxygen reactant other than the iron-based powder for an oxygen reactant are not particularly restricted, and conventionally known components used in oxygen reactants may be used. For example, additives may be added to the iron-based powder. Examples of the additives include activated carbon, salt water, and the like. Further, the oxygen reactant may be sealed in a bag of air-permeable packaging material. Examples of the bag include bags made of non-woven fabric and open-pore polyethylene overlaid together, bags made of paper and open-pore polyethylene overlaid together, and the like. The oxygen reactant may consist of the iron-based powder for an oxygen reactant.

### Examples

The iron-based powders for an oxygen reactant used in the present examples were each prepared by the following procedure.

First, iron powder was prepared from molten steel by a water atomizing method.

Next, 1 kg of the iron powder was agitated with a high-speed mixer (granulator model: LFS-GS-2J, produced by Fukae Powtech Co., Ltd.) to obtain the iron-based powder for an oxygen reactant used in the present examples. All of the iron-based powders for an oxygen reactant were iron powders. Agitation conditions were as follows: rotational speed of agitator blades in sample loading container: 500 rpm, agitation time: 0 min to 180 min.

The method for calculating the lattice interplanar spacing obtained from the diffraction intensity curve corresponding to the (110) diffraction plane of α-Fe crystal among the diffraction peaks of the X-ray diffraction of the iron-based powder was as follows.

First, X-ray diffraction measurements were performed using an X-ray diffractometer (SmartLab, produced by Rigaku Holdings Corporation). The iron-based powder to be measured was scanned using Cu-Kα characteristic X-rays (wavelength: 1.54178 angstrom) at a scanning speed of 4°/min and a measurement angle range of 35° to 55°. The diffraction intensity curve corresponding to the (110) diffraction plane of α-Fe crystal was obtained. The lattice interplanar spacing was then calculated from the diffraction intensity curve.

For the present examples, an oxygen reactivity evaluation of the iron-based powder for an oxygen reactant was carried out as follows.

For each sample, 2 g of an aqueous solution of sodium chloride having a concentration of 8 mass % was added to 20 g of the iron-based powder and mixed. The sample was then sealed inside a gas barrier zipper bag with oxygen gas barrier properties (HSC160-ST, produced by As One Corporation) and allowed to stand at 25° C. for 1 h to allow the sample to reach room temperature. The sample was then placed in a paper cup (SD-729, produced by Strix Design, Inc.) and a temperature sensor connected to a data logger (TR-71wf, produced by T&D Corporation) was inserted in the center of the sample. After inserting the temperature sensor, temperature measurements were taken at 1 min intervals to determine the time elapsed until the temperature of the sample reached 40° C. and maximum arrival temperature.

Table 1 lists the measurement results for the iron-based powder for an oxygen reactant according to each Comparative Example and each Example according to the present disclosure.

TABLE 1

| | | | Evaluation of oxygen reactivity of | |
|---|---|---|---|---|
| | | | iron-based powder | |
| | Agitation time of iron- | Lattice | | Maximum |
| | based powder with | interplanar | | arrival |
| | high-speed mixer | spacing | Elapsed time to | temperature |
| Test No. | (min) | (angstrom) | reach 40° C. (min) | (° C.) |
| Comparative Example 1 | 0 | 1.990 | — | 35 |
| Comparative Example 2 | 1 | 1.995 | — | 36 |
| Comparative Example 3 | 2 | 1.998 | — | 39 |
| Example 1 | 3 | 2.002 | 295 | 44 |
| Example 2 | 5 | 2.010 | 280 | 46 |
| Example 3 | 10 | 2.014 | 270 | 47 |
| Example 4 | 15 | 2.020 | 250 | 50 |
| Example 5 | 30 | 2.045 | 230 | 54 |
| Example 6 | 60 | 2.100 | 180 | 62 |
| Comparative Example 4 | 120 | 2.142 | 145 | 70 |
| Comparative Example 5 | 180 | 2.168 | 130 | 72 |

The iron-based powders of Examples 1 to 6, where the lattice interplanar spacing was 2.000 angstrom or more due to agitation for an appropriate time using a high-speed mixer, each reached a maximum temperature of 40° C. or more and had excellent oxygen reactivity, in contrast to the iron-based powders of Comparative Examples 1 to 3, where the lattice interplanar spacing was less than 2.000 angstrom.

Among these, for Examples 2 to 6, the lattice interplanar spacing was 2.010 angstrom or more, and therefore the maximum arrival temperature was 45° C. and the elapsed time to reach 40° C. was shorter, indicating better oxygen reactivity.

Further, for Examples 4 to 6, the lattice interplanar spacing was 2.020 angstrom or more, and therefore the maximum arrival temperature was 50° C. and the elapsed time to reach 40° C. was shorter, indicating particularly good oxygen reactivity.

In contrast, for Comparative Examples 4 and 5, the lattice interplanar spacing was larger than 2.100 angstrom, and therefore the maximum arrival temperature was 70° C. or more and the elapsed time to reach 40° C. was less than 150 min, which are ranges that makes use as an oxygen reactant difficult. The ranges that make use as an oxygen reactant difficult are, under the conditions of the present examples, when the maximum arrival temperature is 70° C. or more and the elapsed time to reach 40° C. is less than 150 min.

1. An iron-based powder for an oxygen reactant, the iron-based powder having a lattice interplanar spacing of 2.000 angstrom or more and 2.100 angstrom or less, as determined from a diffraction intensity curve corresponding to the (110) diffraction plane of α-Fe crystal among the diffraction peaks of X-ray diffraction.

2. An oxygen reactant using the iron-based powder for an oxygen reactant according to claim 1.
